(19) United States
(12) Patent Application Publication
(10) Pub. No.: US 2005/0132700 A1
(43) Pub. Date: Jun. 23, 2005

(54) Converting energy from flowing fluids into electrical energy

(76) Inventor: Edwin Newman, Toluca Lake, CA (US)

Correspondence Address: Edwin Newman, Unit#3, 11038 Camarillo St., Toluca Lake, CA, 91602, US

(21) Appl. No.: 10/838,737

(22) Filed: May 5, 2004

Related U.S. Application Data
(63) Continuation-in-part of application No. 10/742,983, filed on Dec. 23, 2003.

(51) Int. Cl. F16D 31/02

(52) U.S. Cl. 60/398

(57) ABSTRACT

A new type of diverging nozzle is used to convert the energy of wind and subsurface ocean current into electrical energy. The nozzle is of either spherical or teardrop shape with a small hole in the surface facing the fluid stream. The fluid is made to exit through the surface where the widest diameter of the shape is. The fluid is drawn out by the Bernouilli Effect into the passing fluid stream. As the fluid is accelerated through the small hole the fluid in a tube whose first entrance is near the small hole has its pressure reduced. The tube's second entrance is an inlet tube to a Bourdon Tube. The flexing of the Bourdon tube is made to operate an electric generator through certain gearing. As long as there is a pressure difference between the fluid within the tube and the atmosphere then pressure within the Bourdon Tube can be alternated by valves so electric power output is maintained. Offshore, no moving parts are employed in the invention. The invention is also applied to recover energy needed to rotate a wheel, which may be a gear. Instead of a Bourdon tube a secondary turbine is used.

Prior application Ser. No. 10/742,983 filed Dec. 23, 2003 abandoned. This application is a continuation-in-part.

### BACKGROUND OF THE INVENTION

1. Field of the Invention

The present invention relates to the conversion of the pressure energy of flowing fluids into electrical energy. In particular the invention relates to the conversion of pressure energy from the wind, subsurface ocean currents into electrical energy and the recovery of some of the energy used to rotate shafts.

2. The Prior Art

Wind and subsurface ocean currents are fluids possessing mechanical energy. The two relevant components of mechanical energy are pressure energy and kinetic energy. Up to now only some few efforts hve been made to convert the pressure energy of these fluids into electricity. Yet the pressure energy of these two fluids as they naturally occur is far greater than their kinetic energy.

Hydroelectric turbine generators are a prime example of devices which convert pressure energy into electrical energy. A pressure head is artificially built up in differentiation with the pressure of the surrounding atmosphere. Theoretical power output is calculated as this pressure difference multiplied by the rate of flow.

The relevant technology for converting the pressure energy of the wind into electrical energy is U.S. Pat. No. 5,709,419 to Roskey. Pressure energy is converted to kinetic energy by using a Venturi flume with the kinetic energy compounded with the use of a manifold. The manifold lies outside the Venturi flume so the advantage of using a manifold is also minimized since pipe friction can be very great.

For converting the pressure energy of subsurface ocean currents into electricity the U.S. Patent most relevant to this invention is U.S. Pat. No. 6,568,181 B1 to Hassard et al. Here an airflow is drawn through an air turbine ashore through a pipe to an offshore Venturi tube's throat, as may sometimes be observed with a manometer. The speed of the current as it is accellerated through the throat determines the speed of the airflow. But to avoid large energy losses through the airpipe due to friction a large and expensive pipe is needed.

Energy used to rotate shafts is partly recovered by so-called cogeneration schemes by recycling exhausted energy. This involves complicated and expensive equipment.

These problems are overcome by the present invention.

### SUMMARY OF THE INVENTION

There is first of all a teardrop-shaped object elevated into the wind. The object is oriented so its blunt end is made to face the oncoming current. The object is in two separate portions the division being on a plane through the object's widest diameter called an anterior dome and a posterior cone. There is sufficient structure to unite the separated parts of the object together. Through the center of the anterior dome shped portion is a hole and by this hole is a tube leading to an apparatus elsewhere. As wind flows past this teardrop shaped object wind tends to be drawn through this hole at high velocity and out between the rims of the anterior and posterior portions of the object at the prevailing current velocity due to the lifting force.

This object is a form of a diverging nozzle arranged to reduce pressure in the tube to make an energy sink. The energy used to make the sink is converted into electrical energy by a Bourdon tube geared to operate an electric generator. The object is modified for use of subsurface ocean currents as a working fluid by making the posterior portion like the anterior portion. The invention need need not be revolved to face an oppositely flowing current and has no moving parts below the waterline. Ashore the tube is made to conduct pressure away from a Bourdon tube so as to operate a Bourdon tube. The Bourdon tube is placed at the same depth as the diverging nozzle offshore to maximize pressure differences.

The invention is also used to recover energy used to revolve discs mounted on shafts such as turbines, gears, pumps and fans. If a tube is led from one of these devices through the shaft then as the disc is made to turn air will be drawn through the tube and this flow can be used to drive a secondary turbine.

The first object of this invention is to overcome the stated problems of the prior art.

The second object is to provide inexpensive and effective electric power from wind and subsurface ocean currents.

The third object of the invention is to provide a mechanism to recover energy needed to rotate a shaft by using the lifting force near the rim of a wheel mounted on the shaft.

The attainment of the foregoing and related objects, features and advantages should be more readily apparent to those skilled in the relevant arts after a review of the following more detailed description of the invention, taken together with the drawings in which:

### BRIEF DESCRIPTION OF THE DRAWINGS

FIG. 1 is a side view of the diverging nozzle partly cut away,

FIG. 1a is a cross-sectional view of the diverging nozzle as used to convert the energy of subsurface ocean currents into electricity

FIG. 2 is a perspective view showing how the invention is applied to convert ocean current energy into electrical energy, with references to other Figures,

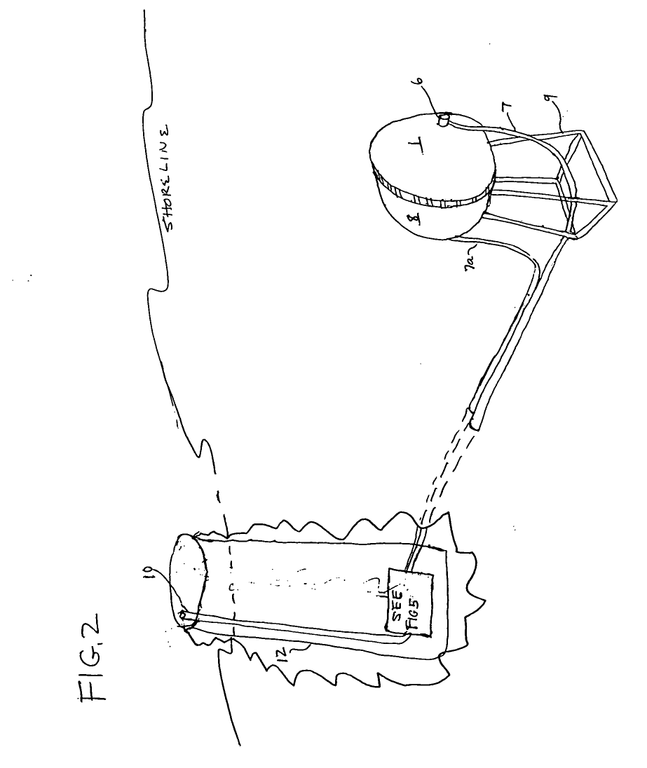

FIG. 3 is a perspective view showing how the invention is applied to convert wind energy into electrical energy, with references to other Figures,

FIG. 4 is a perspective view showing how the present invention converts wind energy into electrical energy using a Bourdon tube.

FIG. 5 shows a perspective view without supporting structure of how the invention converts ocean current energy into electrical energy using pistons and a Bourdon tube.

FIG. 6 is a perspective view without supporting structure showing how energy used to rotate a shaft may be partly recovered by using this invention to operate a secondary turbine.

### DETAILED DESCRIPTION OF THE INVENTION

### First Preferred Embodiment

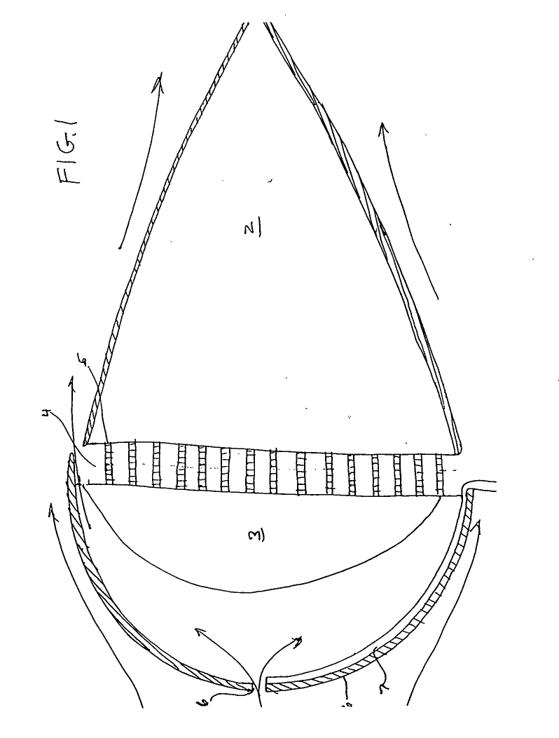

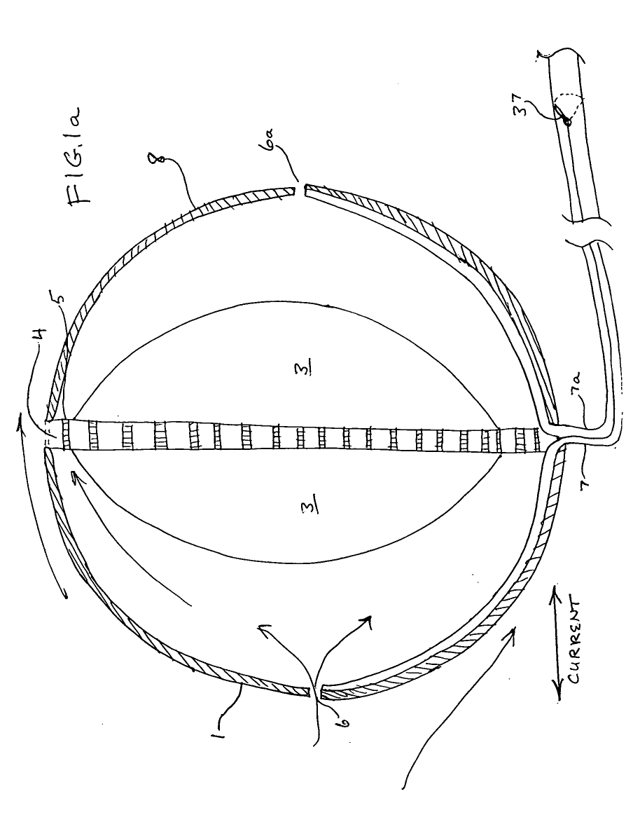

Turning to FIG. 1 there is shown a cut-away section of a hollow dome 1 fixed to a hollow cone 2 by intermittent spacers 5 making space 4. There is shown hole 6 and a tube 7 whose open end lies near hole 6. A second hollow dome 3 is affixed to hollow dome 1 at its rim.

In operation, as working fluid, which is wind, passes around the teardrop shape 1,2 this working fluid is pulled through hole 6 and out space 4 with dome 3 serving as a further guide to the working fluid.

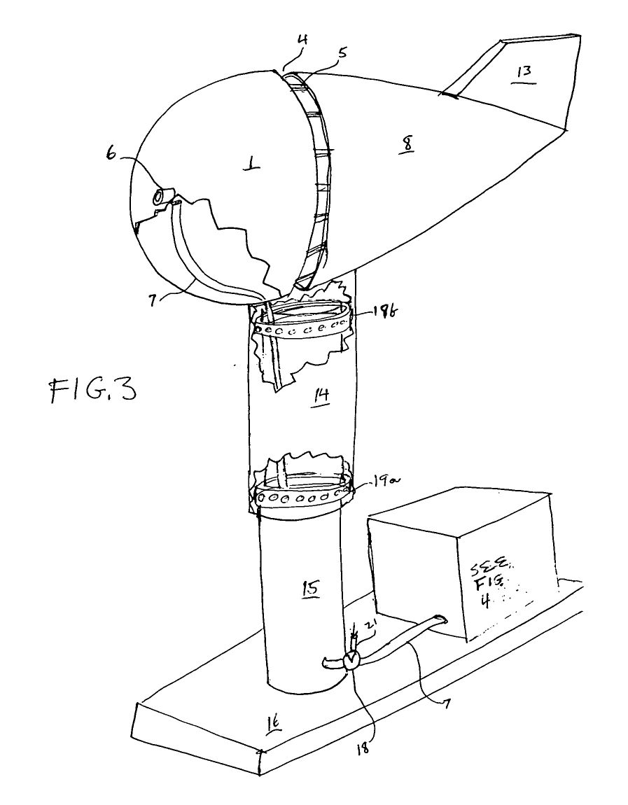

In FIG. 3 we see the apparatus of FIG. 1 mounted on base 16, tube 15 and telescoped tube 14. Thrust bearings 19a,b allow the apparatus to be rotated according to wind direction by rudder 13.

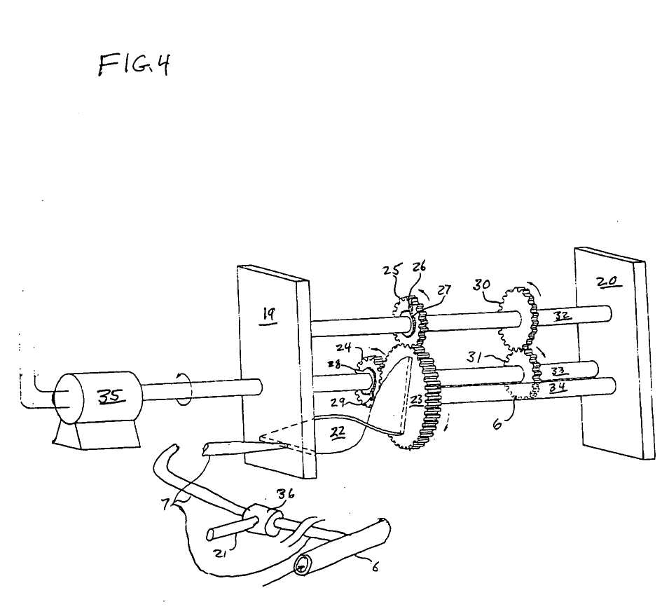

FIG. 4 shows how varying pressure in tube 7 may be converted into electrical energy. Valve 36 is a three way valve admitting either reduced pressure from hole 6 or atmospheric pressure from tube 21 which is open to the atmosphere. Mounted on supports 19,20 are three shafts, 32,33,34. On shaft 32 are mounted spur gear 30 which is made to mesh with gear 31 on shaft 33 and gear 25 meshing with pinion gear 23 on shaft 34. Also on shaft 33 is mounted gear 24 which is also made to mesh with gear 23. Ratchet 27 is mounted with gear 25 and ratchet 28 is mounted with gear 24. Pawl 26 is made to engage ratchet 27 in one direction and pawl 29 is made to engage ratchet 28 in the opposite direction. Shaft 33 is the driveshaft which is made to drive generator 35. Twist-type Bourdon tube is affixed to support 19 and a face of gear 23.

In operation as Bourdon tube 22 is pressurized and depressurized gear 23 is made to be rotated in one direction or the other. Due to the arrangement of gears 23,24,25,30,31 and ratchets 27,28 and pawls 26,29 driveshaft 33 will always be made to drive generator 35 in one direction.

### Second Preferred Embodiment

In FIG. 1a there is shown how to apply the apparatus of FIG. 1 to convert the energy of subsurface ocean energy to electrical energy ashore. Support 9 supports the apparatus of FIG. 1a on the bottom of the ocean so holes 6,6a are made to face an oncoming current which may change direction 180 degrees. Pressure energy in pipe 7 is correspondingly reduced at the end of pipe 7 at the bottom of excavation 12 when 3-way valve 36 is opened. Pipe 7a is led to near hole 6a for use when the current reverses direction. Valve 37 is made to alternately open and close pipes 7,7a according to the prevailing direction of the current.

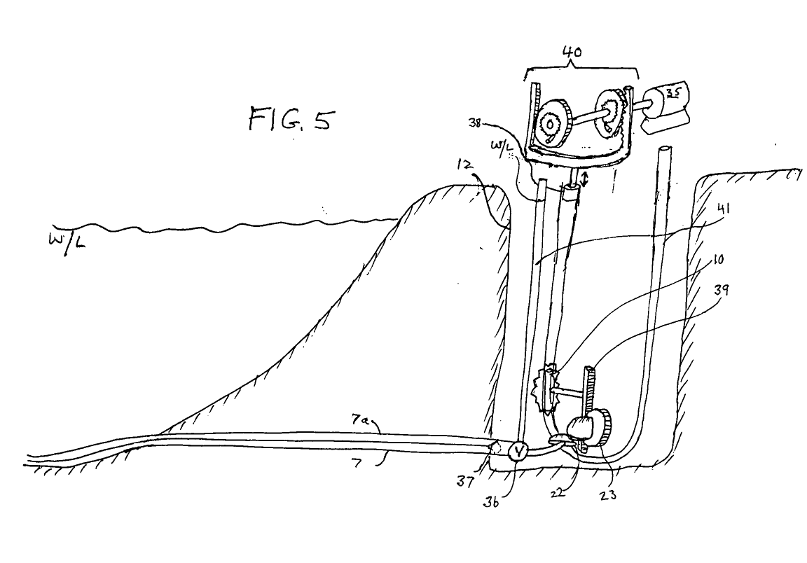

In FIG. 5 we see an alternative way to convert varying pressure in tube 7 into electricity as the invention is applied to the conversion of the energy of subsurface ocean currents. Tube 7 is led into an onshore excavation 12 and is made to end horizontally as a Bourdon tube 22. Three way valve 36 is revolved and pressure from tube 21 alternates with the lower pressure in tube 7. This operates rack 39 and piston 10. U-tube 41 is full of water. Piston 38 operates the racks of mechanical converter 40 as described in U.S. Pat. No. 25,550 thus operating generator 35 in a single direction. At this point it should be pointed out that the structure of FIG. 4 is parallel to the structure disclosed by U.S. Pat. No. 25,550 in that there will be output regardless of the pressure difference involved. A cam needs a minimum pressure difference to operate. To continue, in FIG. 5 we see one leg of U-tube 41 is longer than the other. This is to counterweight piston 38 and structure 40 with the water in the higher leg.

### Third Preferred Embodiment

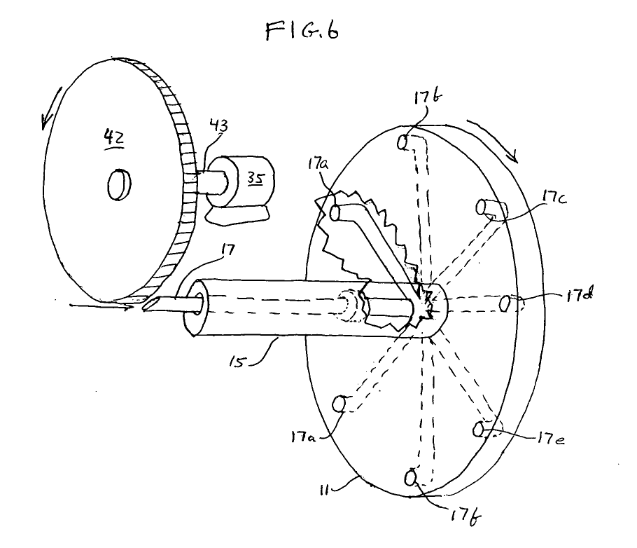

Turning to FIG. 6 we see a wheel and axle device as a disc 11 mounted on shaft 15. Tube 17 is located radially within disc 11 with openings near the rim. Tube 17 is bent at disc 11 axis and laid through the axis of shaft 15 which is operatedly connected to turbine 42, shaft 43 and generator 35. Rotateable seal 46 is mounted on tube 17 so only a portion of tube 17 revolves with disc 11.

In operation as disc 11, possibly a waterwheel, vehicle tire, or a gear is made to rotate then air is thrown out of tube 17 through openings 17,a-g. which each are of the same diameter as tube 17. These openings are near disc 11 rim. This is accomplished by inertia and a lifting force on the air in tube 17. The lowered pressure in tube 17 provides an energy sink to operate turbine 42 and electric generator 35.

From the above description it is apparent that the preferred embodiments achieve the objects of the present invention. Alternative embodiments and various modifications of the depicted embodiments will be apparent to those skilled in the relevant arts.

1-7. (canceled)

8. An energy converting apparatus comprising a tube whose first end is end is open to passing air, said first end operatedly connected to a device comprising a diverging nozzle means further comprising:
a. a hollow dome means,
b. a hollow shape means selected from the group of (1) dome means and (2) cone means, said hollow dome means and said hollow shape cone means fixedly attached to each other along their respective rims said rims being spaced apart and connected intermittently by suitable means,
c. an inner wall means within said diverging nozzle means to guide flow of a fluid through said space between said rims, and
d. a hole means in the center of said hollow dome means and oriented so said hole means is parallel to the earth's surface so as passing fluid draws other fluid through said space defined by said rims fluid is drawn through said hole means at a greater velocity than said passing fluid's velocity, and
said tube second end operatedly connected to a power conversion device comprising a bourdon tube means,
a three-way valve operatedly connected to said bourdon tube means inlet, a first inlet of said valve being said tube, a second inlet of said valve open to atmospheric pressure and an outlet of said valve being operably connected to said bourdon tube, and an electric generator so as said fluid air passes electricity is produced.

9. An energy conversion apparatus comprising a tube whose first end is open to passing water, said first end operatedly connected to a device comprising a diverging nozzle means described in claim 9, and wherein said cone means is a dome means said tube second end operatedly connected to a power conversion device comprising:
a. a verticaly disposed U-tube full of water,
b. a first piston within said U-tube and fixedly attached to a gear rack and operated by a bourdon tube means located near the lowest point of said U-tube and operatedly connected to a pinion gear,
c. a second piston within the end of a leg of said U-tube,
d. a double rack and pinion means, each rack and pinion means operably connected to said piston within said leg,
e. a three way valve, operably connected to said bourdon tube means inlet, a first inlet of said valve being said tube, a second inlet of said valve open to atmospheric pressure and an outlet of said valve being operably connected to said bourdon tube, and
f. generator means operably connected to said pinions of said double rack and pinion means, so that operating said three-way valve will cause said first piston to move reciprocally and operate said device to cause electricity to be produced by said generator.

10. The apparatus of claim 9 wherein said bourdon tube means is located in a hole as deep as the depth of said diverging nozzle means is located.

11. An energy conversion apparatus comprising a tube whose first end is fixedly attached to a wheel and said tube means are laid radially within said wheel so when said wheel is made to rotate said fluid is moved through said tube and tube means and exits said tube means near said wheel's rim, and wherein said tube second end is led through a shaft upon which said wheel is mounted, said second end formed as a turbine jet and operatedly connected to a turbine means and generator so as said wheel is made to rotate electrical power is generated by said generator.
